(19) United States
(12) Patent Application Publication
(10) Pub. No.: US 2025/0310828 A1
(43) Pub. Date: Oct. 2, 2025

(54) SYSTEMS AND METHODS FOR MODEL MONITORING OF CHANNEL STATE INFORMATION PREDICTION AND COMPRESSION

(71) Applicant: InterDigital Patent Holdings, Inc., Wilmington, DE (US)

(72) Inventors: Anouar Yatribi, Greater London (GB); Mihaela Beluri, Jericho, NY (US); Ahmet Serdar Tan, London (GB); Patrick Tooher, Montreal (CA)

(73) Assignee: InterDigital Patent Holdings, Inc., Wilmington, DE (US)

(21) Appl. No.: 18/623,185

(22) Filed: Apr. 1, 2024

(51) Int. Cl. H04W 28/04; H04W 28/06

(52) U.S. Cl. CPC H04W 28/04; H04W 28/06

(57) ABSTRACT

A wireless transmit/receive unit (WTRU) may receive configuration information for channel state information (CSI) prediction and compression. The WTRU may measure a CSI prediction error and/or a CSI compression error, for example to obtain a total combined CSI error. The total combined CSI error may include the sum of the CSI prediction error and the CSI compression error. The WTRU may determine a CSI error condition type, for example based on the total combined CSI error. The CSI error condition type may include one or more of a CSI prediction limited condition type, a CSI compression limited condition type, and/or a combined CSI prediction and compression limited condition type. The WTRU may send a message, for example to a network and/or a network entity. The message may include an indication of the determined CSI error condition type.

### BACKGROUND

Artificial intelligence/machine learning (AI/ML) based channel state information (CSI) enhancements may include reduction of the CSI feedback reporting overhead. AI/ML based CSI prediction may mitigate channel aging and/or reduce the CSI feedback overhead.

AI/ML based CSI compression may reduce the overhead with respect to non-AI/ML CSI feedback, however AI/ML based CSI compression needs further improvement.

### SUMMARY

A wireless transmit/receive unit (WTRU) may receive configuration information for channel state information (CSI) prediction and compression. The WTRU may measure a CSI prediction error and/or a CSI compression error, for example to obtain a total combined CSI error. The total combined CSI error may include the sum of the CSI prediction error and the CSI compression error. The WTRU may determine a CSI error condition type, for example based on the total combined CSI error. The CSI error condition type may include one or more of a CSI prediction limited condition type, a CSI compression limited condition type, and/or a combined CSI prediction and compression limited condition type. The WTRU may send a message, for example to a network (NW) and/or a network entity (NE). The message may include an indication of the determined CSI error condition type. Although described in context of a CSI error condition, in some examples multiple CSI error conditions may be used.

The WTRU may determine a relative CSI error, for example based on the total combined CSI error and one or more of the CSI prediction error or the CSI compression error. The relative CSI error may include one or more of a relative CSI prediction error and/or a relative CSI compression error. The WTRU may determine the CSI error type to be the CSI prediction limited condition type, for example when the relative CSI prediction error exceeds a threshold associated with the total combined CSI error. The WTRU may determine a time window associated with CSI prediction. The WTRU may determine the CSI error condition type to be the CSI compression limited condition type, for example when the relative CSI compression error exceeds a threshold associated with the total combined CSI error.

The WTRU may determine the CSI error type to be the combined CSI prediction and compression limited condition type, for example when a difference between the CSI prediction error and the CSI compression error is less than a threshold. The WTRU may determine a CSI compression configuration including a CSI instance threshold. The message may additionally, or alternatively, include one or more of the determined CSI compression configuration and/or an associated index. Additionally, or alternatively, the message may include one or more of an indication of the measured CSI prediction error and/or CSI compression error. The WTRU may determine parameters associated with CSI prediction, for example based on one or more of the measured CSI prediction error and/or CSI compression error, and/or on a CSI prediction configuration.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example of a WTRU and a network (NW).

FIG. 3 is an example of a CSI process.

FIG. 4 is another example of a CSI process.

FIG. 5A shows an example of a prediction error relative to an index.

FIG. 5B shows an example table.

FIG. 6 shows another example of a CSI process.

### DETAILED DESCRIPTION

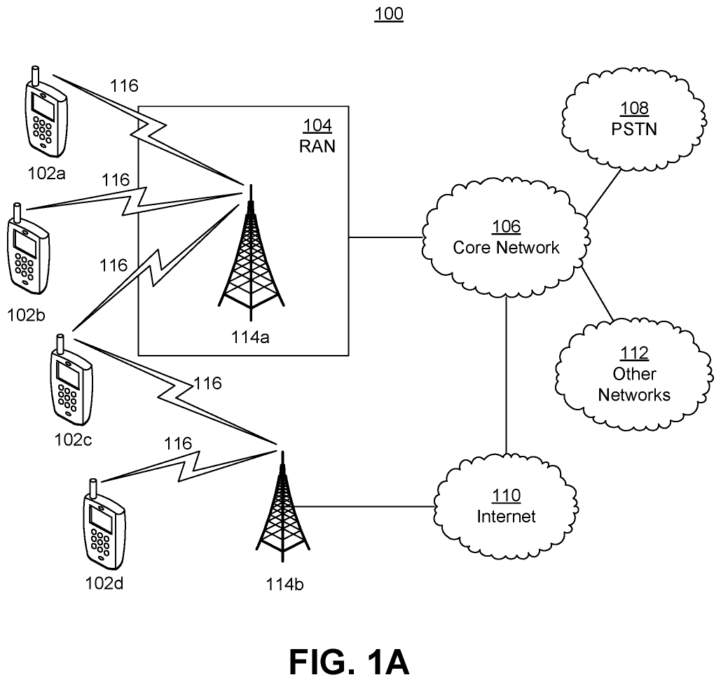

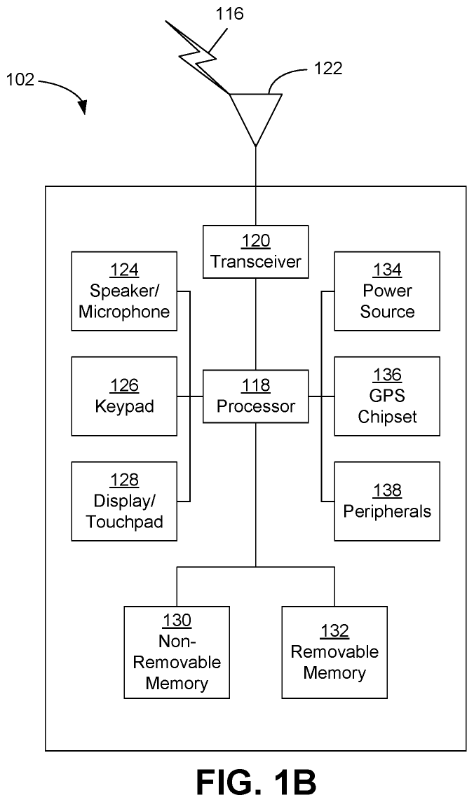

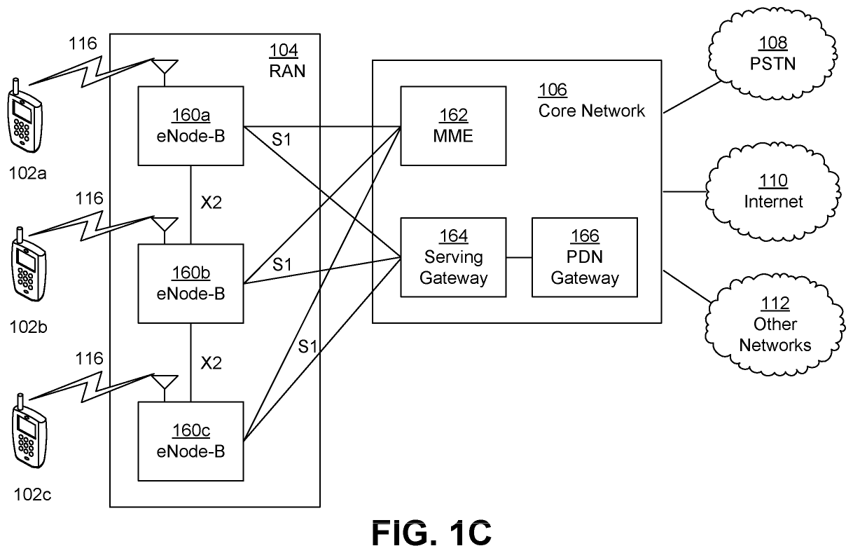

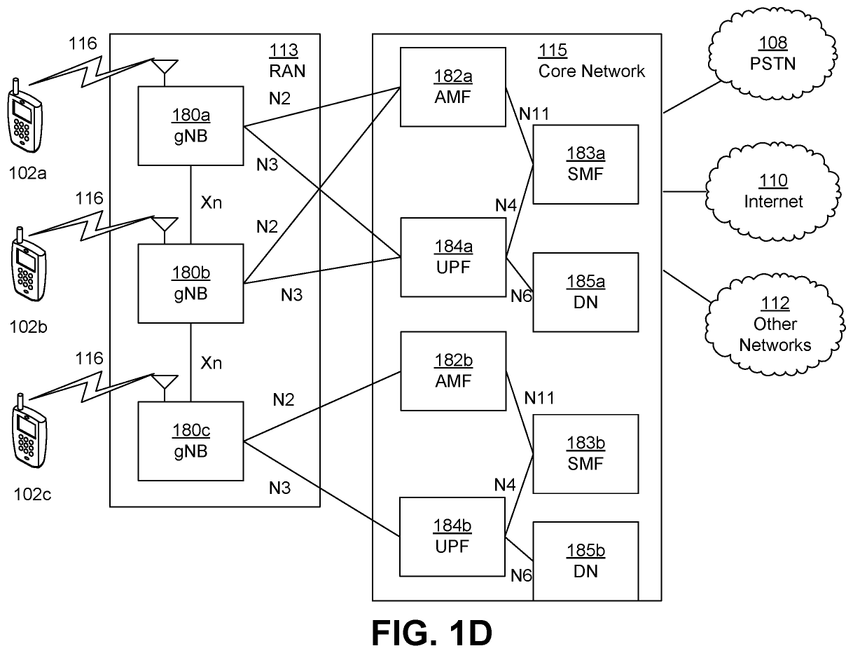

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency communications (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

New radio (NR) multiple input multiple output (MIMO) may support eType II codebook for predicted precoding matrix indicator (PMI), which for example may use traditional (e.g., non-AI/ML) approaches to derive the predicted PMI. However, the AI/ML approach to CSI prediction plus compression may improve this, for example with support for model monitoring.

For scenarios where functionality is implemented in two separate and/or sequential ML models for example, such as the AI/ML CSI prediction plus AI/ML CSI compression, identifying the source of and/or the main contributor to performance degradation may be useful for achieving and/or maintaining the desired system performance. CSI compression using a two-sided model may present a challenge.

Systems and methods as herein may use WTRU-side CSI prediction and/or compression with separate prediction and compression models. Systems and methods as herein may describe how to identify the source of degradation (e.g., prediction, compression, or combined), and/or how to determine a configuration of the CSI prediction and CSI compression to meet target CSI reconstruction performance for given payload constraints.

AI/ML CSI compression plus prediction may improve the performance of AI/ML based CSI feedback. Processing may include multiple historical CSI instances to predict one or more future CSI instances. Processing may additionally, or alternatively, include compression of the one or more predicted future CSI instances.

CSI prediction may use a single side AI/ML prediction model located at the WTRU (e.g., referred to as the WTRU-sided model). The AI/ML prediction model may be based on recurrent neural network (RNN) and/or long short-term memory (LSTM) model architectures, for example to leverage the historical CSI instances (e.g., channel estimates based on (e.g., an indication of) the received CSI-reference signal (RS)) in the observation window to predict one or more future CSI instances. The AI/ML-based CSI compression may use a two-sided autoencoder (AE) model, where the encoder part (e.g., WTRU-side encoder) is located at the WTRU-side and/or performs the compression. The decoder part, for example located at the network side (e.g., NW/NE-side decoder), may perform the reconstruction based on (e.g., an indication of) the received compressed CSI.

Monitoring the performance of the AI/ML models may help ensure consistent system performance across different deployments, channel condition(s), local condition(s), and/or more. ML models may not always generalize well, for example when trained in one set of channel condition(s) (e.g., outdoor) and deployed in a different set of channel condition(s) (e.g., indoor). Model performance monitoring may be useful in the life cycle management (LCM) of the AI/ML models. Systems and methods are provided herein for model performance monitoring of AI/ML CSI prediction plus compression.

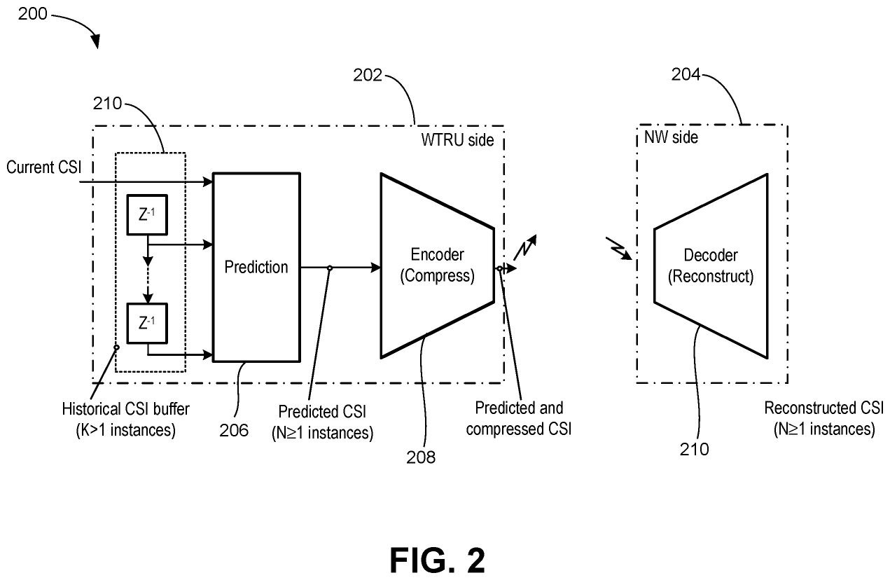

FIG. 2 is a system diagram illustrating an example 200 of a WTRU 202 and a network (NW) or network entity (NE) 204. The WTRU 202 may perform CSI prediction and/or compression. For example, a WTRU may perform combined CSI prediction and compression. The WTRU 202 may perform prediction at prediction block 206. Input to the prediction block 206 may include a current CSI and/or historical (e.g., prior) CSI, for example from a buffer 210. The WTRU 202 may perform compression at an encoder 208. The WTRU 202 may determine and/or report one or more CSI error condition types. The WTRU 202 may determine the one or more CSI error condition type as a function of channel measurements and/or (e.g., configured) performance monitoring thresholds. The WTRU 202 may report the one or more CSI error condition type as a function of channel measurements and/or (e.g., configured) performance monitoring thresholds. The WTRU 202 may determine (e.g., detect) operation in CSI prediction limited condition. The WTRU 202 may determine and/or report (e.g., preferred) parameters, for example of the WTRU-side CSI prediction. The (e.g., preferred) parameters may be determined and/or reported as a function of channel measurements and/or configured performance monitoring thresholds. The WTRU 202 may determine (e.g., detect) operation in a combined CSI prediction and compression error condition type. The WTRU 202 may determine and/or report (e.g., preferred) WTRU-side CSI compression configuration per CSI instance in the prediction window, for example as a function of measurements and/or an index of the prediction instance in the prediction window.

The WTRU 202 may perform combined CSI prediction and compression. The WTRU 202 may determine the CSI error condition type as a function of channel measurements and/or configured performance monitoring thresholds. The WTRU may report (e.g., to the network 204) the CSI error condition type as a function of channel measurements and/or configured performance monitoring thresholds. Additionally, or alternatively, the WTRU 202 may report the predicted and compressed CSI to the network 204. The WTRU 202 may be capable of performing combined CSI prediction and compression and/or may receive (e.g., an indication of) configuration information for combined CSI prediction and compression reporting. Configuration information may include one or more of a CSI-RS configuration, a CSI feedback reporting configuration, a CSI prediction configuration (e.g., observation window and/or prediction window), a CSI compression configuration, and/or a performance monitoring threshold. The network 204 may include a decoder 212, for example for reconstructing CSI.

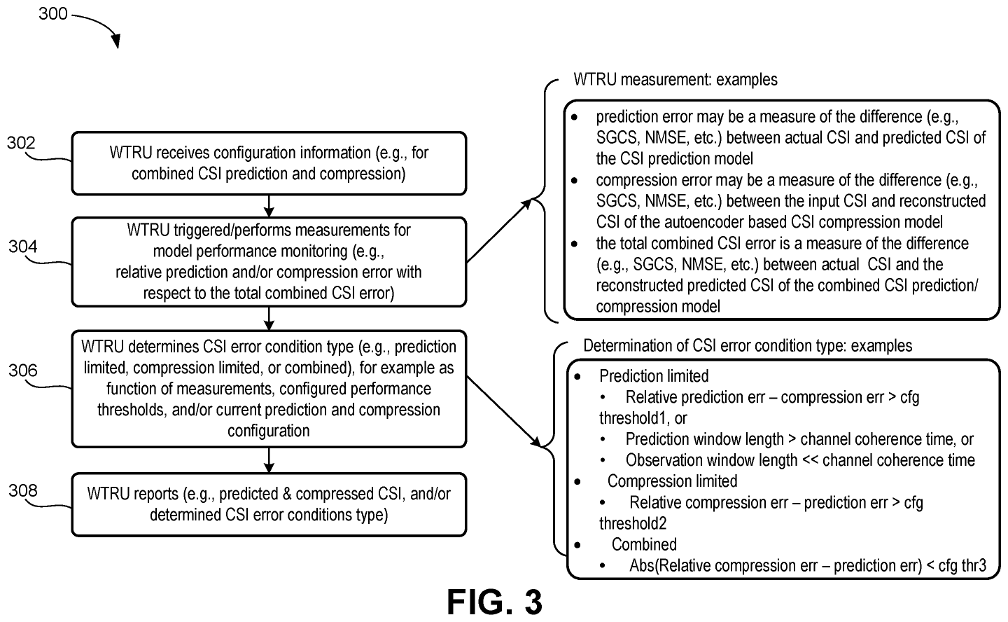

FIG. 3 is an example 300 of a CSI process. At 302 the WTRU may receive (e.g., an indication of) configuration information. The configuration information may be for combined CSI prediction and compression. At 304 the WTRU may be triggered to (e.g., determine to) perform one or more measurements for combined CSI prediction and compression performance monitoring, for example of WTRU-side models. Additionally, or alternatively, at 304 the WTRU may perform one or more measurements. For example, the WTRU may determine a relative prediction and/or a compression error with respect to the total combined CSI error. A measurement may include one or more of channel measurements and/or statistics, prediction estimation error metrics, compression reconstruction error metrics, total combined CSI error, a relative prediction error for one or more CSI instances in the prediction window, and/or relative compression error with respect to the total combined CSI error. Additionally, or alternatively, the one or more channel measurements and/or statistics may include one or more of time domain channel property (TDCP), reference signal received power (RSRP), and/or signal to interference plus radio noise (SINR) associated with the CSI-RS (e.g., in the observation window), Doppler, channel coherence time, first/second order stats, and/or distribution metrics for out of distribution detection.

A prediction error may include a difference (e.g., squared generalized cosine similarity (SGCS), and/or normalized mean square error (NMSE), etc.) between actual CSI and predicted CSI, for example of the CSI prediction model. Compression error may include a measure of the difference (e.g., SGCS, NMSE, and/or etc.) between the input CSI and a reconstructed CSI, for example of an autoencoder based CSI compression model. A total combined CSI error may include a measure of the difference (e.g., SGCS, NMSE, and/or etc.) between actual CSI and a reconstructed predicted CSI, for example of the combined CSI prediction/compression model.

At 306 the WTRU may determine the CSI error condition type. The WTRU may determine the CSI error condition type as a function of (e.g., based on) one or more of the measurements for combined CSI prediction and/or compression performance monitoring, and/or a current combined CSI prediction and/or compression configuration. A CSI error condition type may be determined to be one or more of CSI prediction limited condition, CSI compression limited condition, and or combined.

CSI prediction limited condition may include (e.g., be determined) where a relative prediction error is equal to or exceeds the relative compression error by a configured threshold. CSI compression limited condition may include (e.g., be determined) when the relative compression error is equal to or exceeds relative prediction error by a configured threshold. Combined may include (e.g., be determined) when the difference between relative prediction error and relative compression error is equal to or less than a configured threshold. The WTRU may report the predicted and/or compressed CSI, and/or the determined CSI error condition type. At 308 the WTRU may report a message, for example to the network. The message may include one or more of a predicted CSI, a compressed CSI, a predicted and compressed CSI, and/or the determined CSI error condition type.

Identification of the source of degradation (e.g., prediction, compression, or combined), may enable adaption of the parameters of the current prediction and/or compression blocks, which for example may reduce the overhead by reducing the need for one or more of model finetuning, model switching, and/or model transfer/delivery. CSI prediction limited condition may include (e.g., be determined) when the WTRU operates in condition where the CSI prediction error dominates the overall error of the combined CSI prediction and compression blocks. For example, the CSI prediction error may exceed a threshold value of an overall error. CSI prediction limited, prediction limited, and/or CSI prediction limited condition and prediction limited condition may be used interchangeably as herein. CSI compression limited condition may include (e.g., be determined) when the WTRU operates in condition where the CSI compression reconstruction error dominates the error of the combined CSI prediction and compression blocks. For example, the CSI compression reconstruction error may exceed a threshold value of an overall error. The terms CSI compression limited, compression limited, CSI compression limited condition, and/or compression limited condition may be used interchangeably herein.

Combined CSI prediction and compression error condition may indicate (e.g., be determined) that the separate contribution of the CSI prediction to the overall error of the combined CSI prediction and compression may be comparable to the separate contribution of the CSI compression to the overall error of the combined CSI prediction and compression. CSI error condition type may indicate (e.g., be determined) whether the WTRU operates in CSI prediction limited condition, in CSI compression limited condition, and/or in combined CSI prediction and compression error condition. The terms combined CSI prediction and compression may include (e.g., be determined) when to sequentially process the CSI using at least two separate blocks/modules. A first block may perform CSI prediction. A second block may perform compression of the predicted CSI(s). Combined CSI prediction and compression may herein be used interchangeable with CSI prediction plus compression. Compression rate operations may include data compression operations, for example based on autoencoders. Compression rate may be determined based on the ratio between the input (e.g., uncompressed) size and the output (e.g., compressed) size. High compression rates may be associated with (e.g., mean) more compression of the input data. Low compression rates may be associated with (e.g., mean) less compression of the input data. Additionally, or alternatively, for example regarding the channel response, the terms raw channel, full channel, and/or full channel response matrix may be used interchangeably herein.

There may be WTRU configuration and/or measurements for combined CSI prediction and compression model monitoring. A WTRU may receive (e.g., an indication of) and/or determine configuration information for measurement. Additionally, or alternatively, a WTRU may receive (e.g., an indication of) and/or determine configuration information for reporting. For example, a WTRU may perform CSI-RS measurement based on a configuration (e.g., information). The WTRU may report based on a configuration (e.g., information). A WTRU may be configured to perform combined CSI prediction and compression. The WTRU may receive (e.g., an indication of) CSI-RS configuration (e.g., information), for example to perform the CSI measurements. The CSI-RS configuration information may be periodic, semi-persistent, and/or aperiodic. The WTRU may receive (e.g., an indication of) the configuration information for CSI reporting, which for example may be periodic, semi-persistent, and/or aperiodic. In some examples, the WTRU may receive configuration information for performing measurements (e.g., CSI measurement) and receive configuration information (e.g., separate configuration information) for reporting on those measurements. In other examples, the WTRU may receive configuration information that configures the WTRU for both CSI measurements and reporting.

The WTRU may receive (e.g., an indication of) and/or determine a configuration of an AI/ML CSI prediction model. The configuration of the AI/ML CSI prediction model may include (e.g., be for) one or more of a configuration of a prediction window, a configuration of an observation window, a metric to use for performance measurement and/or error detection, a threshold for error detection, statistical measurements for out of distribution (OOD) detection, a threshold for OOD event detection, and/or CSI prediction model information.

A configuration of the prediction window may include the number of predicted CSI instances in the prediction window, N, and/or the period (e.g., time) between consecutive predicted CSI instances, d. A configuration of the observation window may include the number of historical CSI samples K, in the observation window and/or the period (e.g., time) between consecutive CSI in the observation window, m. The number of historical CSI samples K, in the observation window may be equal to or less than the configured ML prediction model capability.

Metrics to use for performance measurement and/or error detection may include one or more of NMSE, mean square error (MSE), SGCS, and/or the like. Thresholds for error detection may include one or more of a time domain channel property (TDCP) threshold and/or a prediction error threshold (e.g., corresponding to the configured performance metrics, for example SCGS, NMSE, and/or etc.). The WTRU may use metrics for statistical measurements for OOD detection, for example to evaluate the distribution of the input data and/or compare with the data distribution in the training dataset. The WTRU may determine that an OOD event occurred, for example when the WTRU measures a (e.g., significant) difference between the actual data distribution (e.g., at inference time) and the data distribution in the training dataset. Thresholds for OOD event detection may include energy thresholds. CSI prediction model information may include model capability information, for example case the model is transferred/delivered to the WTRU. Model capability information may include one or more of a (e.g., maximum) number of instances in the prediction window and/or a (e.g., maximum) buffer size for the observation window. The configuration may additionally, or alternatively, include information on the dataset used for model training, for example one or more of minimum WTRU speed, maximum WTRU speed, and/or statistical properties of the channel (e.g., coherence bandwidth (BW) of the channel, and/or line of sight (LOS)/non line of sight (NLOS) properties). Additionally, or alternatively, the configuration may include the domain for the CSI historical samples at the prediction model input (e.g., raw channel and/or eigenvectors). A speed as herein, for example a maximum WTRU speed and/or minimum WTRU speed, may include an absolute speed or a relative speed. For example, the speed may be relative to another device and/or entity (e.g., a WTRU or a network/network entity).

The WTRU may receive (e.g., an indication of) and/or determine a configuration of the AI/ML CSI compression model. The configuration of the AI/ML CSI compression model may include one or more of a compression type, a compression configuration, CSI compression encoder model information, and/or proxy decoder information. Compression type may include an indication of whether the predicted CSI instances are to be compressed separately, or jointly (e.g., compression of more than 1 CSI prediction instance). The configuration may include a lookup table, for example in the case of separate compression of the CSI predicted instances. A lookup table may include one or more rows with thresholds for the prediction error, and/or corresponding compression rate(s). A compression configuration may include a (e.g., maximum) number of CSI instances to be compressed, for example in case of joint compression of multiple CSI. Although a lookup table is described herein, it is contemplated that the information may be provided to the WTRU in formats other than in a lookup table such as a list.

CSI compression encoder model information, for example in case the encoder model is transferred/delivered to the WTRU, may include one or more of model backbone information, domain information (e.g., whether compression is performed in the raw channel or eigenvector domain), pre-processing information, quantization parameters, and/or supported compression rates. The configuration may additionally, or alternatively, include information on the dataset used for model training, for example statistical properties of the channel (e.g., coherence BW of the channel, and/or LOS/NLOS properties). Proxy decoder model information may include an indication of a proxy decoder model. The WTRU may use the proxy decoder model to measure the CSI reconstruction accuracy. The proxy decoder model information may include the backbone type and/or information on the training dataset, for example if the proxy decoder model is transferred/delivered to and/or received by the WTRU.

A WTRU may receive (e.g., an indication of) and/or determine a configuration for CSI error event detection and/or CSI error event type determination. The configuration for detecting CSI error events and/or determining the CSI error type may include one or more of a threshold for the relative compression error and relative prediction error comparison, a threshold (e.g., corresponding to the configured metric) for the measured prediction error relative to the total (e.g., combined) CSI error, a threshold for prediction estimation error per predicted CSI instance, a threshold for the absolute difference between the relative compression error and the relative prediction error, and/or a threshold for the CSI reconstruction error.

A threshold for the relative compression error and relative prediction error comparison, may use (e.g., be based on) the configured metric. The threshold for the relative compression error and relative prediction error comparison may be used to determine whether the WTRU operates in CSI prediction limited condition and/or in CSI compression limited condition. The WTRU may use a threshold (e.g., corresponding to the configured metric) for the measured prediction error relative to the total (e.g., combined) CSI error to determine if it operates in CSI prediction limited condition. The WTRU may use a threshold for the measured compression error relative to the total (e.g., combined) to determine if it operates in CSI compression limited condition. The WTRU may use a threshold for the absolute difference between the relative compression error and the relative prediction error, for example to determine if the WTRU operates in combined CSI prediction and/or compression error condition.

A WTRU may perform measurements for combined CSI prediction and compression model monitoring. Measurements may include WTRU measurements of CSI prediction errors. A WTRU may perform measurements for the errors from the CSI prediction AIML block. Measurements may be based on input and/or output statistical distributions, for example at the prediction block. Statistical calculations/metrics may include one or more of cumulative distribution function (CDF) and/or probability density function (PDF) of the input and/or output samples, first-order statistics, second-order statistics, and/or statistical distance. The statistical calculations/metrics may include statistical distribution of data at the input and/or output of an AIML CSI prediction block, for example to compare against the distribution of training data at the input and/or output of the CSI prediction. For example, if by comparing the mean and/or standard deviation of the actual data to the mean and/or standard deviation of the training data (e.g., at the AIML CSI prediction input) a significant difference is detected, there may be an indication of error (e.g., that prediction errors may occur). First-order statistics may include one or more of mean, standard deviation, and/or variance. Second-order statistics may include one or more of autocorrelation of one or more (e.g., each) historical CSI sample (e.g., input) and/or output of the CSI prediction AIML model, and/or cross-correlation between two or more CSI samples in the observation window. Statistical distance may include a distance between the input/output distributions and the training dataset distribution, for example one or more of squared distance, Mahalanobis distance, Bhattacharyya coefficient, Kullback-Leibler (KL) divergence, Z score, and/or energy-based score.

The WTRU may additionally, or alternatively, perform measurements for OOD detection of samples, for example input to the CSI prediction AIML model. The WTRU may use distribution distances and/or the calculated statistics for determining if the input samples are in or out of distribution with respect to the distribution of the training dataset of the CSI prediction AIML model. The WTRU may generate and/or transmit an OOD report. The OOD report may include the measured statistical metrics and/or the OOD determination. The WTRU may include (e.g., be configured with) a (e.g., separate) AIML model, for example for the detection of anomalies in data and/or OOD input samples.

The WTRU may collect a set of measurements, for example related to the channel and/or one or more other applicable conditions. The set of measurements may enable the WTRU to identify if the one or more other applicable conditions are aligned with those assumed (e.g., determined) during model training (e.g., for models specific for a site/cell or area, or models trained on a specific range of WTRU speeds, etc.). The WTRU may perform measurements of one or more of the speed, the time-variability of the channel for example via the channel correlation amplitude for the TDCP report, and/or more channel measurements (e.g., Doppler, channel coherence time, and/or RSRP and SINR associated with the CSI-RS in the observation window, etc.).

The WTRU may calculate one or more metrics for the prediction error estimate (e.g., NMSE and/or SGCS, for different predicted CSI instances), for example for a CSI prediction performance estimate. The WTRU may receive (e.g., an indication of) CSI-RS associated with (e.g., different) predicted CSI instances within the prediction window. The WTRU may calculate prediction error metrics between (e.g., corresponding) channel estimates and the predicted CSI samples.

A WTRU may perform measurements of CSI compression reconstruction errors. The WTRU may perform measurements related to the distribution of the predicted CSI instances, for example at the input of the encoder (e.g., equivalently at the output of the CSI prediction AIML block). The WTRU may calculate the distribution of the predicted CSI instances at the input of the encoder, for example up to a prediction window size. The WTRU may perform measurements of the statistical metrics for the OOD report, for example one or more of statistical distances, first-order statistics, second-order statistics, and/or energy-based scores. The WTRU may perform calculations, for example the same calculations, for the input samples to the CSI prediction model. The WTRU may calculate (e.g., determine) the measurements according to the configuration of (e.g., specific to) the CSI compression AIML block (e.g., encoder).

The WTRU may use one or more metrics (e.g., NMSE and/or SGCS), for example for CSI compression reconstruction error. The WTRU may determine the reconstruction error of the CSI compression two-sided AIML model. The WTRU may apply a WTRU-side proxy decoder, which for example may allow for reduction of the overhead needed for performance monitoring based on ground truth labels that may be shared between the WTRU and the network (NW)/network element (NE). The WTRU may perform CSI compression of one or more predicted CSI instances, for example according to the prediction window. The WTRU may apply the proxy decoder to reconstruct the predicted CSI samples, for example after quantization. The WTRU may alternatively, or additionally, generate synthetic channel noise perturbations and/or apply to them the compressed samples, for example before applying the proxy decoder. Generation of synthetic channel noise perturbations and/or application to the compressed samples may further approach the real reconstruction performance of the decoder at NW/NE side, for example if the WTRU-side proxy decoder is aligned with the NW/NE-side decoder.

The WTRU may determine the reconstruction error performance, for example by using the decoder at the NW/NE-side. The WTRU may one or more multiple proxy decoders, and/or may calculate an estimate of the NW/NE-side reconstruction error performance (e.g., by averaging the individual reconstruction errors provided by one, some or each proxy decoder).

A WTRU may perform measurements of relative errors. The WTRU may perform measurement of the total/overall combined error (e.g., prediction and compression error), for example using different metrics. The WTRU may use error-based metric, for example NMSE and/or SGCS. The error-based metric may be calculated from the reconstructed samples and/or the ground truths (e.g., the channel estimates applied as inputs to the CSI prediction AIML model). The WTRU may determine the overall combined performance, for example based on the accuracy metric and/or a throughput (e.g., the system throughput). The WTRU may combine options as herein and/or determine combined performance based on multiple metrics (e.g., options).

The WTRU may perform measurements for life cycle management (LCM) of the combined prediction and compression model. The WTRU may use a proxy decoder, for example to reconstruct the CSI samples and/or estimate the combined error performance of the combined CSI prediction and compression system. The WTRU may request and/or receive (e.g., an indication of) assistance from a NW/NE, for example to determine an estimate of the combined error. For example, the WTRU may request and/or receive (e.g., an indication of) assistance when the WTRU does not apply a proxy decoder.

A WTRU may determine the relative error of the prediction and/or the reconstruction, for example based on the calculated estimates of the prediction and compression errors and/or the overall (e.g., total) combined error. The WTRU may determine the relative prediction and compression errors, for example by calculating error ratios. Error ratios may give an indication about error impact/contribution of one or more (e.g., each) block (e.g., prediction and/or compression). Relative error (e.g., for prediction and/or compression) associated with prediction and/or compression may be close to 1, for example if error from the respective block is more dominant with respect to the overall combined performance, and/or vice-versa. The WTRU may determine the relative errors, for example by calculating the difference between respective errors (e.g., prediction and/or compression errors) and the overall combined error. The WTRU may determine the relative performance and/or error dominance, for example in terms of accuracy percentage. For example, the WTRU may determine (e.g., first) the prediction accuracy, compression accuracy, and/or (e.g., then) the overall combined accuracy. A relative accuracy for each AIML block with respect to the overall combined accuracy may be determined by WTRU, for example by calculating the respective ratios and/or differences.

A WTRU may perform measurements for model performance monitoring, for example for jointly trained CSI prediction and CSI compression models. The WTRU may perform different measurements as compared to the case when the models are separately trained, for example where the AIML models for CSI prediction and for CSI compression are separate and/or operate sequentially. Additionally, or alternatively, the WTRU may perform different measurements as compared to the case when the models are separately trained when the models were trained jointly (e.g., same training dataset and/or same objective function).

The WTRU may not decide to determine an OOD report based on input and/or output distributions of the CSI prediction model in some examples. Statistical measurements specific to the CSI prediction inputs may be used for determining an OOD report, for example if both AIML models were trained jointly using the same training dataset. The WTRU may determine the statistical distance between the input CSI samples (e.g., data points) up to an observation window, and the training dataset distribution. The WTRU may use different metrics, for example similar to the separate training case. The WTRU may use a specific/dedicated classifier (e.g., non AIML or AIML based). The classifier may perform detection/classification of OOD input samples (e.g., K channel estimates). The WTRU may detect (e.g., within the observation window) that few samples are OOD while other samples are in distribution, for example depending on the observation window size.

There may be one or more triggers for WTRU measurements, for example for model performance monitoring. A WTRU may include at least two separate AIML models for CSI prediction plus compression and/or may be triggered to perform measurements for performance monitoring. There may be WTRU-based triggers. For example, a WTRU may collect measurements and/or perform model monitoring based on its triggers. The WTRU may be triggered by the NW/NE. For example, a WTRU may receive an indication from a NW/NE to collect measurements and/or may start performance monitoring of a CSI prediction plus compression supported system (e.g., based on the indication).

There may be WTRU-autonomous triggers. A WTRU may perform measurements for performance monitoring based on one or more triggers. The one or more triggers may include one or more of a time-based trigger, a periodic time expiry, a change in WTRU-side performance metrics, an inference latency, and/or changes in the one or more applicable conditions, among others.

WTRU may be configured with the time-based trigger(s). A time-based trigger may include periodic time instances to collect measurements for performance monitoring. The periodic time instances may be configured with (e.g., include) a period and offset. The WTRU may be triggered based on a configurable time period, for example since the last measurements for performance monitoring.

A WTRU may be configured with a periodic timer expiry. For example, a WTRU may be configured periodically or aperiodically with a timer (e.g., a time value). The WTRU may be triggered to collect measurements for performance monitoring when the timer expires (e.g., the associated time period ends).

The WTRU may be configured with changes in WTRU-side performance metrics. For example, a WTRU may be triggered when it detects a drop in the performance of one or more of the CSI prediction AIML model, the CSI compression AIML model, and/or the combined CSI prediction plus compression. The performance may be evaluated using the configured WTRU-side metrics. For example, monitoring performance of one or more prediction instance and/or compression instance may be configured (e.g., separately), for example to trigger measurements for the WTRU-side model performance monitoring. The WTRU may be triggered based on NACK frequency, for example when WTRU detects that the NACK frequency is at or above a received or pre-configured threshold.

The WTRU may be configured with inference latency. For example, a WTRU may be triggered by the inference latency of the combined CSI prediction plus compression system. The WTRU may be triggered to collect measurements for monitoring the performance, for example if the inference latency of a CSI instance is above a pre-configured threshold.

The WTRU may be configured with one or more applicable conditions. For example, the WTRU may be triggered based on speed. For example, the WTRU may be triggered when the WTRU speed increases (e.g., rapidly and/or above a threshold). Additionally, or alternatively, a speed or a change (e.g., decrease or increase) in speed may trigger the WTRU. The speed or change in speed may be relative to another device and/or NW/NE. For example, the WTRU may be triggered based on a speed or change in speed relative to another device and/or a NW/NE. The speed and/or change in speed may be compared to the threshold.

The WTRU may be triggered based on the time-variability of the channel based on the TDCP report (e.g., when the channel correlation amplitude is below a pre-configured threshold). The WTRU may be triggered when one or more channel condition measurements (e.g., RSRP, received signal strength indicator (RSSI), reference signal received quality (RSRQ), rank indicator (RI), PMI, channel quality indicator (CQI), SINR, doppler spread, doppler shift, angle of arrival (AoA), angle of departure (AoD), delay spread, average delay, and/or position coordinates) is above or below a threshold. The WTRU may calculate the difference of the current channel condition(s) compared to the last channel condition(s) measurements, and/or may be triggered if the difference is above a threshold.

A WTRU may be triggered by the NW/NE. The NW/NE-based triggers may be based on one or more of an RRC configuration/reconfiguration, reception of a measurement request, a periodic/aperiodic trigger, an environment/scenario change, a change in configuration, a mobility and/or position, and/or an update in an AIML model. The WTRU may receive (e.g., an indication of) a periodic and/or aperiodic RRC configuration/reconfiguration, for example to collect measurements for performance monitoring. The WTRU may receive an indication from the NW/NE to perform measurements and/or activate performance monitoring. An indication may be received via one or more of downlink control information (DCI), medium access control (MAC) control element (CE), and/or radio resource control (RRC) signaling. The WTRU may receive (e.g., an indication of) a periodic and/or aperiodic indication to activate performance monitoring and/or collect measurements.

The WTRU may receive an indication upon a (e.g., fast) change in the environment, (e.g., change from LOS to NLOS, change from NLOS to LOS, change in coverage, and/or a change in the environment is equal to or greater than a threshold). The WTRU may be triggered by a NW/NE based on a change in configuration (e.g., number of transmitter (Tx)/receiver (Rx) antennas, panel, TRP, and/or frequency band, etc.). The WTRU may be triggered by the NW/NE when the WTRU reports a change in speed (e.g., absolute or relative speed) and/or in position (e.g., either may be absolute or relative position to a reference). The WTRU may be triggered by a NW/NE when there is a change in one or more of the AIML models used for CSI prediction or for CSI compression (e.g., after model finetuning, after model transfer, after model switching, and/or after model activation).

There may be WTRU procedures for combined CSI prediction and compression model monitoring. The WTRU may determine a CSI error condition type. The WTRU may evaluate condition for CSI error event detection, for example while performing combined CSI prediction and compression. The WTRU may start (e.g., determine) to evaluate condition for a CSI error event detection, for example upon receiving a request from the NW/NE. The request may include a model performance monitoring request. The CSI error event may indicate that the combined CSI prediction and compression block does not meet the target performance.

The WTRU may determine that a CSI error event occurs when one or more conditions is satisfied. The one or more conditions may be satisfied when one or more of the CSI reconstruction error of the combined CSI prediction and compression block is equal to or exceeds a threshold, an OOD event is detected for historical CSI samples at the prediction block input, a TDCP measured at the CSI prediction block input is equal to or smaller than a configured TDCP threshold, a speed estimated by the WTRU is outside the range of speeds used for training dataset, measured channel properties such as coherence BW of the channel and/or LOS/NLOS properties are outside the range used for model training, and/or the WTRU receives an indication of a CSI error event detected by the NW/NE, among others.

CSI reconstruction error of the combined CSI prediction and compression block may be referred to as the total CSI error. The WTRU may determine that a CSI error event occurs when a CSI reconstruction error of the combined CSI prediction and compression block is equal to or exceeds a threshold. For example, when the prediction window length is N=1 CSI sample, a CSI error event may occur when the CSI reconstruction error measured at the output of a WTRU-side proxy decoder is equal to or exceeds a configured threshold. A CSI error event may occur when the minimum CSI reconstruction error across the CSI instances in the prediction window (e.g., as measured at the output of a WTRU-side proxy decoder) exceeds a configured threshold, for example when the prediction window length is N>1 CSI samples and/or the predicted samples are compressed separately. A CSI error event may occur when the maximum CSI reconstruction error across the CSI instances in the prediction window, as measured at the output of a WTRU-side proxy decoder, is equal to or exceeds a configured threshold, for example when the prediction window length is N>1 CSI samples and/or the predicted samples are compressed separately. The metric for the reconstruction error measurements may be configured as one or more of NMSE, MSE, CS, and/or SGCS.

The WTRU may determine that a CSI error event occurs when an OOD event is detected for historical CSI samples, for example at the prediction block input. The WTRU may perform statistical measurements for the distribution of the channel samples at the input of the CSI prediction block. The WTRU may detect an OOD event at the input of the prediction block, for example when the actual distribution of the channel (e.g., at the CSI prediction input) is significantly different from (e.g., by a threshold) the training dataset distribution. When such an event (e.g., OOD event) is detected for example, the WTRU may determine that a CSI error event occurs. For example, error during the CSI prediction step may impact the compression, which may result in performance degradation for the combined CSI prediction and/or compression.

The WTRU may determine that a CSI error event occurs when TDCP measured at the CSI prediction block input is smaller than a configured TDCP threshold. The samples at the CSI prediction block input may be decorrelated, which for example may degrade the CSI prediction performance and/or (e.g., therefore) the performance of the combined CSI prediction and/or compression.

The WTRU may determine that a CSI error event occurs when the speed estimated by the WTRU is outside the range of speeds used for training dataset (e.g., exceeds a threshold). For example, the training dataset may contain data based on a mix of WTRU low speeds (e.g., 3 km/h to 30 km/h). When the model operates in the vehicular case at higher speeds (e.g., 60 to 120 km/h or higher) for example, the CSI prediction model, the CSI compression model, or both may not generalize well, thus degrading the performance of the combined CSI prediction and compression. The WTRU may compare the estimated speed to the WTRU speed included in the model and dataset configuration information, for example to determine whether a CSI error event occurs.

The WTRU may determine that a CSI error event occurs when measured channel properties, for example coherence BW of the channel and/or LOS/NLOS properties, are outside the range (e.g., a threshold) used for model training. The CSI prediction model and/or the CSI compression model may not generalize well, for example (e.g., therefore) degrading the performance of the combined CSI prediction and compression.

The WTRU may evaluate the CSI error condition type, for example when the WTRU determines that a CSI error event occurred. The CSI error condition type may identify whether a block (e.g., a ML model and/or processing step) has the dominant contribution to the combined CSI prediction and compression errors. The dominant contribution identification may be based on a threshold. For example, CSI error condition type may be evaluated as CSI prediction limited condition, for example when the CSI prediction step has the dominant contribution to the total combined CSI error. The CSI error condition type may be evaluated as CSI compression limited condition, for example when the CSI compression step has the dominant contribution to the total combined CSI error. The CSI error condition type may be evaluated as combined CSI prediction and compression error condition, for example when both the CSI prediction and the CSI compression steps have similar contributions to the total combined CSI error.

The WTRU may evaluate CSI error condition type as CSI prediction limited condition based on one or more of a measured prediction error relative to the total combined CSI error equaling or exceeding a configured or received threshold, relative prediction error equaling or exceeding the relative compression error by a configured or received threshold, a minimum relative prediction error across the CSI instances in the prediction window equaling or exceeding the relative compression error by a configured or received threshold, a relative prediction error of the last CSI instance in the prediction window equaling or exceeding the relative compression error by a configured or received threshold, a minimum relative prediction error across the CSI instances in the prediction window equaling or exceeding the maximum relative compression error across the CSI instances in the prediction window by a configured or received threshold, an average prediction error for the CSI instances in the prediction window equaling or exceeding the total combined CSI error by a configured or received threshold, a prediction window length is equal to or larger than the measured channel coherence time, an OOD event is detected for historical CSI samples at the input of the prediction model, and/or a measured WTRU speed is outside the range of speeds used for training dataset of the CSI prediction model.

The WTRU may evaluate CSI error condition type as CSI prediction limited condition based on the measured prediction error relative to the total combined CSI error (e.g., the relative CSI prediction error) equaling or exceeding a configured or received threshold, for example for the case of prediction window length N=1 CSI instance.

The WTRU may evaluate CSI error condition type as CSI prediction limited condition based on the relative prediction error equaling or exceeding the relative compression error by a configured or received threshold, for example for the case of prediction window length N=1 CSI instance.

The WTRU may evaluate CSI error condition type as CSI prediction limited condition based on the minimum relative prediction error across the CSI instances in the prediction window equaling or exceeding the relative compression error (e.g., the CSI compression reconstruction error averaged over the instances in the prediction window) by a configured or received threshold, for example for the case of prediction window length N>1 CSI instance with separate compression.

The WTRU may evaluate CSI error condition type as CSI prediction limited condition based on the relative prediction error of the last CSI instance in the prediction window equaling or exceeding the relative compression error (e.g., the CSI compression reconstruction error averaged over the instances in the prediction window) by a configured or received threshold, for example for the case of prediction window length N>1 CSI instance with separate compression. The WTRU may evaluate CSI error condition type as CSI prediction limited condition based on the minimum relative prediction error across the CSI instances in the prediction window equaling or exceeding the maximum relative compression error across the CSI instances in the prediction window by a configured or received threshold, for example for the case of prediction window length N>1 CSI instance with separate compression. The WTRU may evaluate CSI error condition type as CSI prediction limited condition based on the average prediction error for the CSI instances in the prediction window equaling or exceeding the total combined CSI error by a configured or received threshold, for example for the case of prediction window length N>1 CSI instance with joint compression.

The WTRU may evaluate CSI error condition type as CSI prediction limited condition based on a prediction window length being equal to or larger than the measured channel coherence time. For example, the WTRU may calculate the number of instances n_{fit} that fit within the channel coherence time, for the configured period (e.g., time) between consecutive prediction instances, d, as: n_{fit}=floor(channel coherence time/d). The WTRU may determine the CSI error condition type as CSI prediction limited, for example if the configured number of prediction instances in the prediction window, N, exceeds (or significantly exceeds) the number of instances n_{fit} that fit within the channel coherence time.

The WTRU may evaluate CSI error condition type as CSI compression limited condition based on one or more of a measured compression error relative to the total combined CSI error equaling or exceeding a configured or received threshold, a relative compression error equaling or exceeding the relative prediction error by a configured or received threshold, a relative compression error of the CSI instances in the prediction window equaling or exceeding the relative prediction error by a configured or received threshold, an OOD event is detected for the CSI samples at the input of the compression block, and/or a measured WTRU speed is outside the range of speeds used for training dataset of the CSI compression model.

The WTRU may evaluate CSI error condition type as CSI compression limited condition based on the measured compression error relative to the total combined CSI error (e.g., the relative CSI compression error) equaling or exceeding a configured or received threshold, for example for the case of prediction window length N=1 CSI instance. The WTRU may evaluate CSI error condition type as CSI compression limited condition based on the relative compression error equaling or exceeding the relative prediction error by a configured or received threshold, for example for the case of prediction window length N=1 CSI instance.

The WTRU may evaluate CSI error condition type as CSI compression limited condition based on the relative compression error of the CSI instances in the prediction window equaling or exceeding the relative prediction error by a configured or received threshold, for example the case of prediction window length N>1 CSI instance with separate compression. The relative compression error may be calculated as the minimum and/or the average relative compression across the CSI instances in the prediction window. The relative prediction error may be calculated for the last CSI instance in the prediction window.

The WTRU may evaluate CSI error condition type as combined CSI prediction and compression error condition based on one or more of an absolute difference between the relative compression error and the relative prediction error being equal to or less than a configured or received threshold, and/or the absolute difference between the relative compression error and the relative prediction error for some or each CSI instance in the prediction window being equal to or less than a configured threshold. The WTRU may evaluate CSI error condition type as combined CSI prediction and compression error condition based on the absolute difference between the relative compression error and the relative prediction error being less than a configured threshold, for example for the case of prediction window length N=1 CSI instance. The WTRU may evaluate CSI error condition type as combined CSI prediction and compression error condition based on the absolute difference between the relative compression error and the relative prediction error for some or each CSI instance in the prediction window being equal to or less than a configured or received threshold, for example for the case of prediction window length N>1 CSI instances with separate compression.

A WTRU may operate in prediction limited condition. A WTRU, for example performing combined CSI prediction and compression, may determine that a CSI error event occurred. The WTRU may determine (e.g., evaluate) the CSI error condition type as CSI prediction limited. The WTRU may perform actions, for example if the CSI error condition is CSI prediction limited. The actions may include determining (e.g., preferred) parameters of a prediction block, for example as a function of measured channel condition and/or a (e.g., current) CSI prediction configuration. For example, the WTRU may determine to perform one or more of reducing a number of prediction instances, reducing the distance (e.g., time) between prediction instances, increasing the number of samples in the observation window, and/or reducing the distance (e.g., time) between historical instances the observation window, among others.

The WTRU may determine to reduce the number of prediction instances. The WTRU may determine the number (e.g., the preferred number) of CSI instances in the prediction window as n_{fit}=floor(channel coherence time/d), for example when the measured channel coherence time is equal to or smaller than the prediction window length. d may represent the period (e.g., time) between consecutive predicted CSI instances. The number (e.g., preferred number) of predicted CSI instances n_{fit} may be equal to or smaller than the configured value N, which for example may in effect reduce the prediction window. The WTRU may alternatively, or additionally, report the prediction window (e.g., preferred prediction window) length, n_{fit}, for example for the current CSI reporting occasion. The WTRU may include information in the feedback report. The information may include or indicate a repetition of the predicted instance of index n_{fit}, for example up to the end of the prediction window. The WTRU may indicate the repetition to the NW/NE.

The WTRU may perform pre-processing (e.g., zero padding from n_{fit} to N CSI instances) at the input of the CSI compression block, for example when the NW/NE configures the WTRU to use the prediction (e.g., preferred prediction) window of n_{fit} instances for a future (e.g., next) reporting occasion. The WTRU may perform a model switch of the CSI compression block and/or may send an indication of the model switch to the NW/NE, for example when the NW/NE configures the WTRU to use the preferred prediction window of n_{fit} instances for a future (e.g., next) reporting occasion.

The WTRU may determine to reduce the distance (e.g., time) between prediction instances. The WTRU may determine the (e.g., preferred) distance d_{pref} between consecutive predicted CSI instances as: d_{pref}=floor(channel coherence time/N), for example when the measured channel coherence time is equal to or smaller than the prediction window length. N may represent the configured number of prediction instances in the prediction window.

The WTRU may determine to increase the number of samples in the observation window. The WTRU may determine to increase the number of CSI instances in the observation window, for example when the observation window is shorter (e.g., much shorter) than the channel coherence time. The WTRU may determine the number (e.g., preferred number) of CSI instances in the observation window, Kₚᵣₑf, as: K_{pref}=floor(channel coherence time/m). m may represent the configured time period between consecutive CSI instances in the observation window (e.g., corresponding to the CSI-RS periodicity). For example, the WTRU may switch the CSI prediction model (e.g., to support the larger number of samples in the observation window).

The WTRU may reduce the distance (e.g., time) between historical instances the observation window. The WTRU may determine to reduce the distance, m, between the CSI instances in the observation window, for example when the distance is equal to or larger (e.g., or much larger/a threshold larger) than the channel coherence time. The WTRU may determine the distance (e.g., preferred distance) between CSI instances in the observation window, m_{pref}, as: m_{pref}=K), where for example K is the number of CSI instances in the observation window.

The WTRU may determine to fine-tune the CSI prediction model. The WTRU may determine to perform a model switch. For example, the WTRU may determine to perform a model switch (e.g., CSI prediction model switch), if the WTRU detects an OOD event. The WTRU may determine to fallback to non-AI/ML based prediction. For example, the WTRU may determine to fall back to non-AI/ML based prediction (e.g., Rel-18 eType-II for predicted PMI), when no AI/ML CSI prediction models applicable to the current channel condition(s) are available (e.g., either locally available at the WTRU-side and/or available for model transfer/delivery from the NW/NE). The WTRU may determine to fallback to reporting the current CSI measurement. The WTRU may determine to fall back to reporting the current CSI, for example in case of very high speeds (e.g., very short channel coherence times).

The WTRU behavior may operate in combined CSI prediction and compression error condition. A WTRU, for example configured with separate CSI prediction and CSI compression, may compute the CSI prediction error for one or more predicted CSIs in the prediction window. The WTRU may compute the CSI prediction error per prediction index based on the historical CSI prediction error per prediction index. For example, the WTRU may compute the historical CSI prediction error per prediction index as a measure of the difference (e.g., SGCS, NMSE, etc.) between an actual CSI and a predicted CSI for one or more of (e.g., each) of the predicted CSI index in the prediction window.

The WTRU may determine compression rate for one or more (e.g., each) of a CSI prediction index, for example as a function of the computed CSI prediction error per prediction index in the prediction window. The WTRU may determine the compression rate per prediction index, for example based on one or more of an analytical model, a look up table, and/or a model with a lower compression rate.

The WTRU may determine the compression rate based on an analytical model. The WTRU may be configured with an analytical model to compute the compression rate R for a given CSI prediction error E, e.g., R=f(E). The WTRU may compute the compression rate Ri for CSI prediction index i with error Ei using the analytical model.

The WTRU may determine the compression rate based on a look up table. The WTRU may be configured with a look up table to determine the compression rate for each CSI prediction instance. For example, the look-up table may comprise one or more rows with thresholds for CSI prediction error and/or corresponding compression rates.

The WTRU may choose/select a model with a lower compression rate. The WTRU may determine the compression rate based on a model (e.g., a selected model) with lower compression rate (e.g., have less compression) for a higher prediction index. The WTRU may be configured with CSI compression models with different compression rates for one or more (e.g., each) of the CSI prediction indices. For example, the compression rate of one or more models (e.g., each model) that are used to compress a CSI prediction instance may decrease (e.g., have less compression) as the prediction index increases. For example, the compression rate Rᵢ for a CSI prediction instance at time i may be higher than the compression rate Rᵢ₊₁ for CSI prediction instance at time i+1.

The WTRU may compress one or more (e.g., each) predicted CSI based on the determined compression rate for the corresponding prediction index. For example, the WTRU may use different AIML-based CSI compression models to compress one or more (e.g., each) of the predicted CSI instances.

A WTRU, for example configured with joint compression of multiple CSI prediction instances, may determine the block size (e.g., subset, group, etc.) for joint compression of one or more CSI prediction instances. For example, the WTRU may determine to compress a first subset of the CSI prediction instances with a first CSI compression model at a time and/or a second subset of the CSI prediction instances with a second CSI compression model at a time. The WTRU may determine one or more subsets of CSI prediction instances, for example based on one or more of a measure on the CSI prediction errors, payload size, and/or overall compression performance, among others.

The WTRU may determine one or more subsets of CSI prediction instances based on a measure on the CSI prediction errors. The WTRU may group CSI prediction instances (e.g., into a subset) based on average prediction errors of the CSI prediction instances. The WTRU may determine to compress a first group of CSI predictions (e.g., indices with average CSI prediction error below a threshold) with a first compression rate, and/or a second group of CSI predictions, (e.g., indices with average CSI prediction error equal to or higher than a threshold) with a second compression rate.

WTRU may determine one or more subsets of CSI prediction instances based on payload size. The WTRU may be configured with a payload size constraint (e.g., to satisfy). The WTRU may determine to compress a first group of predicted CSI instances with or using a first compression rate and/or a second group of predicted CSI instances with or using a second compression rate. The total payload size of the two jointly compressed CSI prediction instances may satisfy the total payload size constraint. The WTRU may determine the first compression rate and/or the second compression rate based on the payload size constraint. The first group of predicted CSI instances may correspond to the first part of the CSI prediction instances in which, for example the CSI prediction error is lower compared to the second part of the CSI prediction instances.

The WTRU may determine one or more subsets of CSI prediction instances based on an overall compression performance. The WTRU may be configured with an overall compression performance, for example measured by SGCS, and/or NMSE, etc. For example, the WTRU may determine a compression rate to compress all the CSI prediction instances at a time to satisfy a compression performance. For example, the WTRU may determine the compression rate based on the average CSI prediction error and/or the maximum CSI prediction error for the prediction window. The WTRU may compress the predicted CSI. The WTRU may compress the predicted CSI based on the determined one or more groups (e.g., subsets), for example according to the determined one or more compression rates using one or more CSI compression models.

The WTRU may operate in compression limited condition. A WTRU may determine (e.g., identify) that the WTRU operating mode is under compression limited condition, for example during performance monitoring of a combined CSI prediction plus compression system. The WTRU may increment a counter and/or frequency specific to the detection of compression limited condition, for example when the WTRU is configured or pre-configured with a counter/frequency threshold. The WTRU may perform model switching to another CSI compression AIML model, for example if the updated counter/frequency is above the threshold.

The WTRU may detect that the WTRU operating mode is compression limited, for example after one or more of the CSI compression model activation, model download, and/or model finetuning. The WTRU may request/recommend model switching from the NW/NE, for example without incrementing the compression limited counter/frequency. A WTRU may be (e.g., previously) operating using a (e.g., previous) AIML model for CSI compression. A WTRU may determine to (e.g., start to) increment a counter up to a limited (e.g., lower) second threshold. The WTRU may compare the compression limited frequencies of the two AIML models and/or may request/receive/recommend/determine (e.g., an indication of) a model switching to the previous model, for example if the new model frequency is higher than that of the previously operating CSI compression AIML model. Additionally, or alternatively, the WTRU may determine to (e.g., start to) increment a counter up to a limited (e.g., lower) second threshold if the model was recently activated (e.g., based on a time constraint and/or based on a number of inference instances) and/or if the WTRU was operating using a previous AIML model for the CSI compression.

The WTRU may detect that the frequency of occurrence of compression limited condition of the current and/or (e.g., all) the supported AIML models (e.g., previously activated in a combined CSI prediction plus compression system) for CSI compression equal to or exceeding a configured threshold. The WTRU may request/recommend performing a fallback to a default CSI reporting configuration, where for example the default CSI reporting configuration may include the CSI corresponding to the most recent received CSI-RS (e.g., indication of the most recent CSI-RS).

The WTRU may indicate combined CSI prediction and compression model monitoring metrics and/or parameters. The WTRU may report an indication of one or more of the CSI prediction and compression model monitoring, the metrics, and/or the parameters, for example to a network. A WTRU may be configured to periodically, aperiodically, and/or semi-persistently report the indication of one or more of the CSI, the CSI prediction and compression model monitoring, the metrics, and/or the parameters.

A reporting instance may include one or more of a predicted CSI, a compressed CSI, a predicted and compressed CSI, a (e.g., determined) CSI error condition type, and/or an identity and/or a set of feedback reports for which a determined CSI error condition type may be applicable. A reporting instance may include or indicate a predicted CSI, for example the output of the CSI prediction module (e.g., CSI prediction AI/ML model output). An input of the CSI prediction module may be one or more channel measurements. A reporting instance may include or indicate a compressed CSI, for example the output of the CSI compression module (e.g., CSI compression AI/ML model output). An input of the CSI compression module may be one or more channel measurements.

A reporting instance may include or indicate a predicted and compressed CSI. The WTRU may input channel measurements into a CSI prediction module and/or may use the output of the CSI prediction module as input to a CSI compression module. The WTRU may report the output of the compression module. The WTRU may input channel measurements into a CSI compression module and/or may use the output of the CSI compression module as input to a CSI prediction module. The WTRU may report the output of the prediction module. For example, a WTRU may input channel measurements into a combined CSI prediction/compression module and/or the WTRU may report the output of the combined CSI prediction/compression module. The WTRU may be configured with the ordering (e.g., compression first/prediction second, and/or prediction first/compression second) and/or type (e.g., separate prediction and compression modules or combined prediction and compression module) of joint prediction and compression CSI reporting.

A reporting instance may include or indicate a determined CSI error condition type. For example, the WTRU may indicate that the dominant source of error for combined prediction and compression is the prediction error. The WTRU may indicate that the dominant source of error for combined prediction and compression is the compression error. The WTRU may indicate that there is no dominant source of error for combined prediction and compression (e.g., that the contribution to the total error of both the prediction error and compression error is similar and/or is within a threshold). For example, the WTRU may determine that one or more of prediction error, compression error, and/or combined prediction and compression error, is above or below a threshold. The threshold may be received, configurable or preconfigured. A reporting instance may include the identity and/or set of feedback reports, for example for which a determined CSI error condition type is applicable. A threshold as herein may refer to an indication of a threshold. For example, a WTRU may receive an indication (e.g., an index) of a threshold.

A WTRU may determine whether to report feedback for one or more of predicted CSI only, compressed CSI only, combined predicted and compressed CSI, and/or CSI uncompressed and without prediction, for example as a function of one or more of the determined CSI error condition type, the prediction error value, the compression error value, the combined prediction and compression error value, and/or comparison of one or more error values and a threshold.

A WTRU may determine and/or update one or more of CSI prediction module parameters, CSI compression module parameters, and/or combined CSI prediction/compression module parameters. The determination and/or update of parameters may be based on one or more of the determined CSI error condition type, the prediction error value, the compression error value, the combined prediction and compression error value, and/or comparison of one or more error values and a threshold.

The WTRU may report, for example in a CSI report, the determination and/or update of parameters (e.g., for one or more of CSI prediction module, CSI compression module, and/or combined CSI prediction/compression modules) and/or request to update one or more parameters. The WTRU may indicate in the report the set of updated parameters and/or the updated values of the parameters. The WTRU may indicate in the report the set of parameters, a request to be updated, and/or a request for updated parameter values. For example, the parameters may include one or more of a prediction window size, a number of prediction outputs, RS parameter(s), a compression rate, a compression type, and/or an input and/or output domain of a module. The prediction window size may include the window size on which measurements are made to enable prediction, which for example may include the window size within which predicted measurements may be determined and/or reported. RS parameters may include one or more of density, periodicity, type, and/or resource allocation. Compression rate may include the maximum and/or average payload of the output of the compression module. Compression type may include a compression for a single time instance and/or joint compression for multiple time instances. The input or output of at least one of the CSI prediction module and/or CSI compression module may include and/or be in the form of one or more of a full channel matrix domain, an Eigen Vector domain, a CQI/PMI/RI format, and/or an AI/ML latent space domain.

A WTRU may determine and/or report the source or cause of error for at least one module. For example, based on one or more measurements or performance metrics, the WTRU may determine and/or report that a source for error for at least one module includes one or more of an inadequately trained AIML model, an inadequate AIML model selection and/or configuration, and/or a combination of CSI prediction AI/ML model and CSI compression AI/ML model that may not be compatible.

The WTRU may determine and/or report that a source for error for at least one module includes an inadequately trained AIML model. The inadequately trained AIML model may include one or more of an AI/ML model for one or more of CSI prediction module, a CSI compression module, and/or combined prediction/compression module that may not be trained for a current scenario/configuration.

The WTRU may determine and/or report that a source for error for at least one module includes and/or indicates an inadequate AIML model selection and/or configuration. For example, the inadequate AIML model selection and/or configuration may include one or more of an AI/ML model for one or more of CSI prediction module, a CSI compression module, and/or a combined prediction/compression module may not be applicable to a current scenario/configuration.

The WTRU may determine and/or report that a source for error for at least one module includes and/or indicates a combination of a CSI prediction AI/ML model and CSI compression AI/ML model that may not be compatible. For example, one or more models (e.g., each model by itself) may have acceptable performance, however in combination the combined performance may be unacceptable. Performance acceptability may be determined by determining the CSI contribution error type and/or at least one error value (e.g., prediction, compression, and/or combined). For example, the error value may be compared to a threshold (e.g., to determine performance acceptability).

For AI/ML model management, a WTRU may report an outcome of an AI/ML model training or retraining, for example as triggered by a determined CSI contribution error type or error value. Additionally, or alternatively, for AI/ML model management, a WTRU may report a request for AI/ML model training or retraining, for example due to a determined CSI contribution error type and/or error value. For AI/ML model management, a WTRU may report an outcome of AI/ML model validation, for example as triggered by a determined CSI contribution error type and/or error value. Additionally, or alternatively, for AI/ML model management, a WTRU may report a request for AI/ML model validation, for example due to or based on the determined CSI contribution error type and/or error value. For AI/ML model management, a WTRU may report an outcome of the AI/ML model selection, for example as triggered by or based on a determined CSI contribution error type and/or error value. Additionally, or alternatively, for AI/ML model management, a WTRU may report a request for the AI/ML model selection, for example due to or based on the determined CSI contribution error type and/or error value.

A WTRU may determine and/or report CSI report rules. A WTRU may determine the type of CSI to report based on one or more of the determined CSI error condition type, the prediction error value, the compression error value, the combined prediction and compression error value, a comparison of one or more error values and a threshold, whether a feedback report is periodic/aperiodic/semi-persistent, the timing of a feedback report, a configuration, and/or an indication in a CSI feedback request, among others.

The type of CSI reported may be associated with (e.g., in) a domain as herein, for example one or more of a full channel matrix domain, an EV domain, a CQI/PMI/RI format, and/or AI/ML latent space domain. The type of CSI may include one or more of a regular CSI, a CSI report of a (e.g., single) set of CSI values, a CSI report of multiple sets of CSI values, and/or a CSI report of one or more sets of CSI values.

The type of CSI may include a regular CSI. For example, regular CSI may be unpredicted and uncompressed. The type of CSI may include a CSI report of a single set of CSI values associated with a single time instance reference. For example, the CSI report may include a single set of predicted and/or compressed CSI values, for example that is associated with a single time instance reference.

The type of CSI may include a CSI report of multiple sets of CSI values. Each set may be associated with a single, for example unique, time instance reference. For example, the CSI report may include multiple sets of predicted and/or compressed CSI values. Each set of predicted and/or compressed CSI values may be (e.g., uniquely) associated with a single time instance reference. Each set of predicted CSI value associated to a single time instance reference may be separately compressed.

The type of CSI may include a CSI report of one or more sets of CSI values. Each set of CSI values may be associated with multiple time instance references. For example, the CSI report may include one or more set(s) of predicted and/or compressed CSI values that, for example may be (e.g., each) associated with (e.g., disjointed) multiple time instance references. Multiple sets of the predicted CSI values (e.g., each associated with a single, possibly unique, time instance) may be jointly compressed.

The WTRU may determine the one or more time instance references of a CSI feedback report based on one or more of the timing of a feedback report, whether a feedback report is periodic/aperiodic/semi-persistent, the type of feedback report, the determined CSI error condition type, the prediction error value, the compression error value, the combined prediction and compression error value, a comparison of one or more error values and a threshold, an indication in a CSI feedback request, and/or a configuration. For example for periodic reporting, the WTRU may include and/or indicate CSI feedback associated with time instance references that are associated with a specific periodic feedback report instance. For example, for aperiodic reporting, the WTRU may include CSI feedback associated with all available and/or as-yet-unreported time instances.

A WTRU may be configured to report CSI one or more of periodically, aperiodically, and/or semi-persistently. The WTRU may determine the timing of at least one report and/or the periodicity of multiple reports based on one or more of a type of CSI report, the determined CSI error condition type, the prediction error value, the compression error value, the combined prediction and compression error value, and/or a comparison of one or more error values and a threshold.

A WTRU may determine and/or report a CSI error condition type. A WTRU may perform combined CSI prediction and compression. The WTRU may determine and/or report the CSI error condition type for example based on channel measurements and/or configured performance monitoring thresholds.

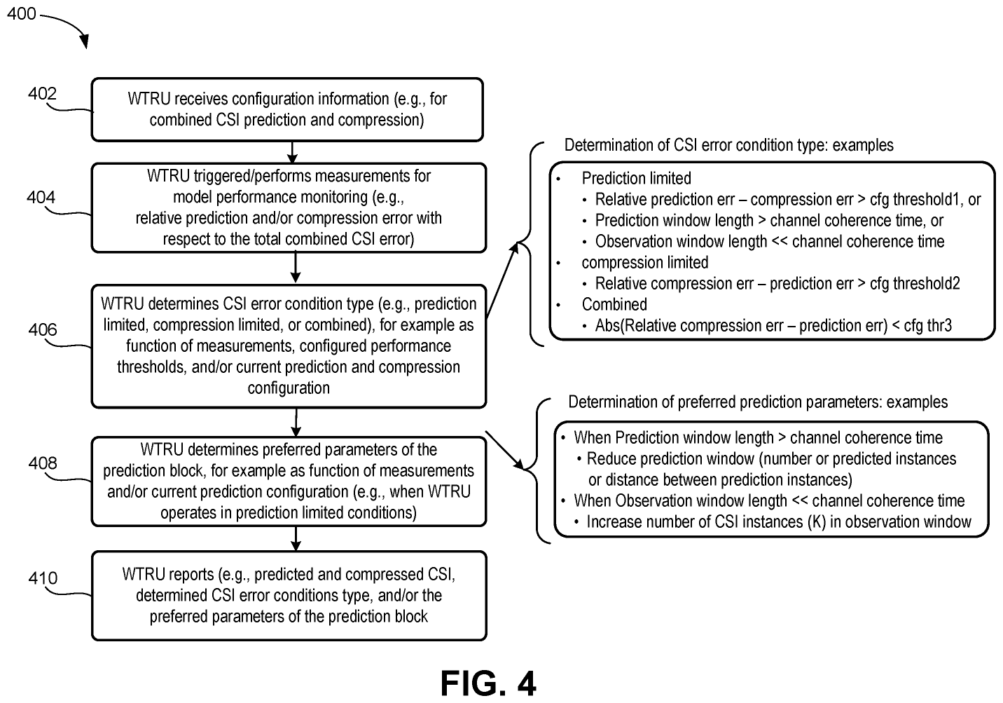

FIG. 4 is another example 400 of a CSI process. At 402 WTRU, for example configured to perform combined CSI prediction and compression may receive (e.g., an indication of) configuration information. The configuration information may be for combined CSI prediction and compression reporting. The configuration information may include and/or indicate one or more of a CSI-RS configuration, a CSI feedback reporting configuration, a CSI prediction configuration (e.g., an observation window and/or a prediction window), a CSI compression configuration, and/or performance monitoring threshold(s).

At 404 the WTRU may be triggered to perform measurements and/or perform measurements for combined CSI prediction and compression performance monitoring, for example of WTRU-side models. Measurements may include one or more of channel measurements and/or statistics, prediction estimation error metrics, compression reconstruction error metrics, a total combined CSI error, and/or a relative prediction error for one or more CSI instances in the prediction window and/or a relative compression error with respect to the total combined CSI error. The channel measurements and/or statistics may include one or more of TDCP, RSRP and/or SINR, for example associated with the CSI-RS in the observation window. Additionally, or alternatively, the channel measurements and/or statistics may include one or more of Doppler, a channel coherence time, first/second order stats, distribution metrics, for example for OOD detection.

At 406 the WTRU may determine the CSI error condition type as a function of the measurements, for example for combined CSI prediction and compression performance monitoring and/or current combined CSI prediction and compression configuration. The CSI error condition type may be determined to be one or more of CSI prediction limited condition, CSI compression limited condition, and/or combined CSI prediction and compression limited condition. CSI prediction limited condition may be determined when the relative prediction error is equal to or exceeds the relative compression error by a configured or received threshold. CSI compression limited condition may be determined when the relative compression error is equal to or exceeds relative prediction error by a configured or received threshold. Combined (e.g., combined CSI prediction and compression limited condition) may be determined when the difference between relative prediction error and relative compression error is equal to or is less than a configured threshold. The WTRU may report, for example to a network/NE, the predicted and compressed CSI and/or the determined CSI error condition type.

At 408 the WTRU may determine (e.g., preferred) CSI prediction parameters when operating in CSI prediction limited condition. A WTRU may detect WTRU operation in CSI prediction limited condition. The WTRU may determine and/or report (e.g., preferred) parameters (e.g., of the prediction block) of the WTRU-side CSI prediction, for example as a function of channel measurements and/or configured performance monitoring thresholds. A WTRU, for example configured to perform combined CSI prediction and compression, may receive (e.g., an indication of) configuration information. The configuration information may be for combined CSI prediction and compression reporting. The configuration information may include and/or indicate one or more of a CSI-RS configuration, a CSI feedback reporting configuration, a CSI prediction configuration (e.g., an observation window and/or a prediction window), a CSI compression configuration, and/or performance monitoring threshold(s). At 410 the WTRU may report a message, for example to the network/NE. The message may include one or more of a predicted CSI, a compressed CSI, and/or the determined CSI error condition type.

The WTRU may be triggered to perform measurements for combined CSI prediction and compression performance monitoring, for example of WTRU-side models. The measurements may include and/or indicate one or more of channel measurements and/or statistics, prediction estimation error metrics, compression reconstruction error metrics, a total combined CSI error, and/or a relative prediction error for one or more CSI instances in the prediction window and/or a relative compression error with respect to the total combined CSI error. Channel measurements and/or statistics may include and/or indicate one or more of TDCP, RSRP and/or SINR, for example associated with the CSI-RS in the observation window. Additionally, or alternatively, channel measurements and/or statistics may include one or more of Doppler, a channel coherence time, first/second order stats, or distribution metrics, for example for OOD detection.

The WTRU may determine the CSI error condition type as a function of the measurements for combined CSI prediction and compression performance monitoring and/or the current combined CSI prediction and compression configuration. The CSI error condition type may be determined to be one or more of CSI prediction limited condition, CSI compression limited condition, and/or combined CSI prediction and compression limited condition. The WTRU may determine the CSI error condition to be CSI prediction limited condition, for example when the relative prediction error is equal to or exceeds the relative compression error by a configured or received threshold. The WTRU may determine the CSI error condition to be CSI compression limited condition, for example when the relative compression error is equal to or exceeds the relative prediction error by a configured or received threshold. The WTRU may determine the CSI error condition to be combined (e.g., combined CSI prediction and compression limited condition), for example when the difference between the relative prediction error and the relative compression error is equal to or is less than a configured or received threshold.

The WTRU may determine preferred parameters of the prediction block, for example as a function of the measurements for combined CSI prediction and compression performance monitoring and/or the current CSI prediction configuration. The WTRU may determine the preferred parameters of the prediction block, for example when the WTRU determines (e.g., detects) that the WTRU operates in CSI prediction limited condition. The WTRU may determine to decrease the prediction window (e.g., number of predicted instances or distance between predicted instances), for example when the prediction window length is equal to or exceeds the channel coherence time. The WTRU may determine to increase the observation window (e.g., number of instances in the observation window), for example when the observation window length is equal to or shorter than the channel coherence time.

The WTRU may report one or more of the predicted and/or compressed CSI, the determined CSI error condition type (e.g., CSI prediction limited), and/or the (e.g., preferred) parameters of the prediction block, for example to a network/NE.

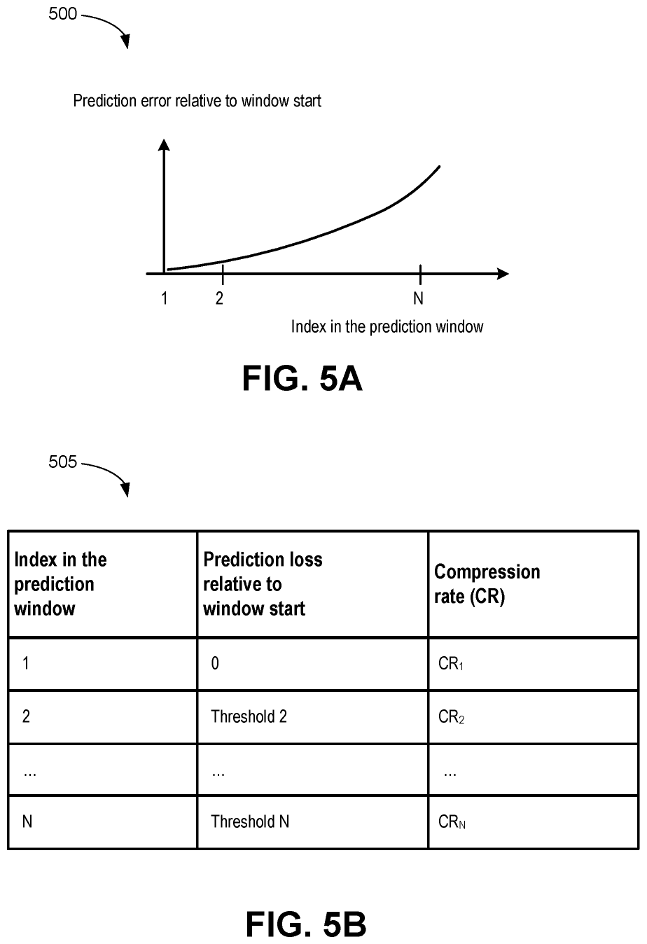

FIG. 5A shows an example 500 of a prediction error relative to an index. FIG. 5B shows an example table 505. A WTRU may determine and/or report (e.g., preferred) WTRU-side CSI compression configuration per CSI instance in the prediction window, for example as a function of measurements and/or an index of a prediction instance in a prediction window. A WTRU, for example configured to perform combined CSI prediction and compression, may receive (e.g., an indication of) a compression configuration for each CSI prediction instance in the prediction window. The WTRU may determine the CSI error condition type as a function of the channel condition and/or prediction and compression configuration. The WTRU may determine the recommended change in compression configuration (e.g., type of model, model ID, model parameters, or compression rate) for one or more (e.g., each) CSI prediction instance(s) in the prediction window as a function one or more of the index of the one or more prediction instance(s) in the prediction window, measured CSI prediction error(s) of the instance(s), and/or configured performance thresholds.

A table, for example as in FIG. 5B may include indices, prediction losses, and/or compression rates. Each index may be associated with a prediction and/or a compression rate. Each index may be an index in a prediction window. Additionally, or alternatively, each prediction loss may be relative to the window start (e.g., prediction window start). One or more of the prediction losses may be a threshold, for example as described herein. The WTRU may determine and/or receive an indication of one or more of the indices, for example in the table.

The WTRU may determine a compression configuration, for example as a function of an index within the prediction window. The WTRU may determine the compression configuration when operating in combined CSI error condition. A WTRU (e.g., detecting that it operates in Combined CSI prediction and compression error condition type) may determine and/or report a (e.g., preferred) WTRU-side CSI compression configuration per CSI instance in the prediction window, for example as a function of measurements and/or the index of the prediction instance in the prediction window.

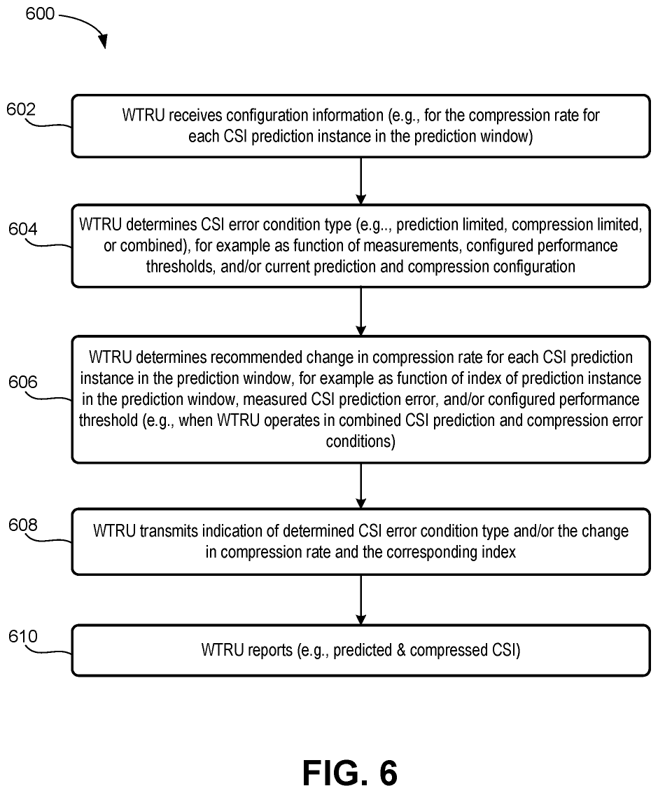

FIG. 6 shows another example 600 of a CSI process. At 602 a WTRU may receive (e.g., an indication of) configuration information, for example for the compression rate for one or more (e.g., each) CSI prediction instance in a prediction window. A WTRU, for example configured to perform combined CSI prediction and compression, may receive (e.g., an indication of) a compression configuration for each CSI prediction instance in the prediction window. At 604 the WTRU may determine the CSI error condition type as a function of one or more of the channel condition, measurement(s), and/or (e.g., current) prediction and compression configuration.

At 606 the WTRU may determine the recommended change in compression configuration (e.g., type of model, model ID, model parameters, or compression rate) for one or more (e.g., each) CSI prediction instance(s) in the prediction window, for example if the WTRU detects that the WTRU operates in the combined CSI prediction and compression error condition type. Additionally, or alternatively, the WTRU may determine the recommended change in compression configuration (e.g., type of model, model ID, model parameters, or compression rate) for one or more (e.g., each) CSI prediction instance(s) in the prediction window as a function one or more of the index of the one or more prediction instance(s) in the prediction window, measured CSI prediction error(s) of the instance(s), and/or the configured performance thresholds.

At 608 the WTRU may transmit an indication of one or more of the determined CSI error condition type (e.g., combined), the recommended change in compression configuration, and/or the corresponding index of the one or more prediction instance(s). At 610 the WTRU may report (e.g., an indication of) the predicted and/or compressed CSI.

Example abbreviations and/or acronyms as herein are shown below.

| | |
|---|---|
| LCM | Life Cycle Management |
| OOD | Out-of-Distribution |
| TDCP | Time Domain Channel Property |
| CE | Control Element |
| CQI | Channel Quality Indicator |
| CSI | Channel State Information |
| DCI | Downlink Control Information |
| DL | Downlink |
| LTE | Long Term Evolution e.g. from 3GPP LTE R8 and up |
| NACK | Negative ACK |
| MIMO | Multiple Input Multiple Output |
| NR | New Radio |
| OFDM | Orthogonal Frequency-Division Multiplexing |
| RRC | Radio Resource Control |
| RS | Reference Signal |
| RSRP | Reference Signal Received Power |
| RSSI | Received Signal Strength Indicator |
| TRP | Transmission/Reception Point |
| UL | Uplink |
| URLLC | Ultra-Reliable and Low Latency Communications |
| WLAN | Wireless Local Area Networks and related technologies |
| | (IEEE 802.xx domain) |

1. A method implemented by a wireless transmit/receive unit (WTRU), the method comprising:
receiving configuration information for channel state information (CSI) prediction and compression;
measuring a CSI prediction error and a CSI compression error to obtain a total combined CSI error;
determining a CSI error condition type based on the total combined CSI error, wherein the CSI error condition type comprises at least one of a CSI prediction limited condition type, a CSI compression limited condition type, or a combined CSI prediction and compression limited condition type; and
sending a message comprising an indication of the determined CSI error condition type to a network.

2. The method of claim 1, further comprising determining a relative CSI error based on the total combined CSI error and at least one of the CSI prediction error or the CSI compression error.

3. The method of claim 2, wherein the relative CSI error comprises a relative CSI prediction error, and wherein determining the CSI error condition type comprises determining the CSI error type to be the CSI prediction limited condition type when the relative CSI prediction error is equal to or exceeds a threshold associated with the total combined CSI error.

4. The method of claim 3, wherein the method further comprises determining a time window associated with the CSI prediction.

5. The method of claim 2, wherein the relative CSI error comprises a relative CSI compression error, and wherein determining the CSI error condition type comprises determining the CSI error type to be the CSI compression limited condition type when the relative CSI compression error exceeds a threshold associated with the total combined CSI error.

6. The method of claim 1, wherein determining the CSI error condition type comprises determining the CSI error type to be the combined CSI prediction and compression limited condition type when a difference between the CSI prediction error and the CSI compression error is equal to or less than a threshold.

7. The method of claim 6, wherein the method further comprises determining a CSI compression configuration including or indicating a CSI instance threshold.

8. The method of claim 1, wherein the message further comprises the determined CSI compression configuration and an associated index.

9. The method of claim 1, wherein the message further comprises an indication of the measured CSI prediction error and CSI compression error.

10. The method of claim 1, further comprising determining parameters associated with CSI prediction based on the measured CSI prediction error and CSI compression error and on a CSI prediction configuration.

11. A wireless transmit/receive unit (WTRU) comprising:
a processor configured to:
receive configuration information for channel state information (CSI) prediction and compression;
measure a CSI prediction error and a CSI compression error to obtain a total combined CSI error;
determine a CSI error condition type based on the total combined CSI error, wherein the CSI error condition type comprises at least one of a CSI prediction limited condition type, a CSI compression limited condition type, or a combined CSI prediction and compression limited condition type; and
send a message comprising an indication of the determined CSI error condition type to a network.

12. The WTRU of claim 11, wherein the processor is further configured to determine a relative CSI error based on the total combined CSI error and at least one of the CSI prediction error or the CSI compression error.

13. The WTRU of claim 12, wherein the relative CSI error comprises a relative CSI prediction error, and wherein the processor configured to determine the CSI error condition type comprises the processor being configured to determine the CSI error type to be the CSI prediction limited condition type when the relative CSI prediction error is equal to or exceeds a threshold associated with the total combined CSI error.

14. The WTRU of claim 13, wherein the processor is further configured to determine a time window associated with the CSI prediction.

15. The WTRU of claim 12, wherein the relative CSI error comprises a relative CSI compression error, and wherein the processor configured to determine the CSI error condition type comprises the processor being configured to determine the CSI error type to be the CSI compression limited condition type when the relative CSI compression error exceeds a threshold associated with the total combined CSI error.

16. The WTRU of claim 11, wherein the processor configured to determine the CSI error condition type comprises the processor being configured to determine the CSI error type to be the combined CSI prediction and compression limited condition type when a difference between the CSI prediction error and the CSI compression error is equal to or less than a threshold.

17. The WTRU of claim 16, wherein the processor is further configured to determine a CSI compression configuration including or indicating a CSI instance threshold.

18. The WTRU of claim 11, wherein the message further comprises the determined CSI compression configuration and an associated index.

19. The WTRU of claim 11, wherein the message further comprises an indication of the measured CSI prediction error and CSI compression error.

20. The WTRU of claim 11, wherein the processor is further configured to determine parameters associated with CSI prediction based on the measured CSI prediction error and CSI compression error and on a CSI prediction configuration.
